(19) United States
(12) Patent Application Publication
(10) Pub. No.: US 2013/0055770 A1
(43) Pub. Date: Mar. 7, 2013

(54) WASHING MACHINE AND CONTROL METHOD THEREOF

(71) Applicants: Hyun Oh KIM, Gwacheon-si (KR); Jun Hyun PARK, Osan-si (KR); Seung Hoon KIM, Suwon-si (KR)

(72) Inventors: Hyun Oh KIM, Gwacheon-si (KR); Jun Hyun PARK, Osan-si (KR); Seung Hoon KIM, Suwon-si (KR)

(73) Assignee: SAMSUNG ELECTRONICS CO., LTD., Suwon (KR)

(21) Appl. No.: 13/594,145

(22) Filed: Aug. 24, 2012

(30) Foreign Application Priority Data
Sep. 1, 2011 (KR) 10-2011-0088680

(51) Int. Cl. G01G 23/01; D06F 21/00

(52) U.S. Cl. 68/139; 73/1.13

(57) ABSTRACT

A method of detecting weight of laundry contained in a washing machine. A calibration mode is provided that is performed separately from a washing mode such that a detection error of the weight of laundry, which occurs due to external environment factors, is calibrated when the weight of laundry is detected using a motor. The calibration mode is provided to find the weight detection offset data of the washing machine based on external environment factors, and to store the weight detection offset data found. When the weight of laundry is detected in a next washing mode, the weight of laundry is calibrated by use of the weight detection offset data of the washing machine, so that the weight of laundry accommodated in the washing machine is precisely detected.

### CROSS-REFERENCE TO RELATED APPLICATIONS

This application claims the benefit of Korean Patent Application No. 2011-0088680, filed on Sep. 1, 2011 in the Korean Intellectual Property Office, the disclosure of which is incorporated herein by reference.

### BACKGROUND

1. Field

Embodiments of the present invention relate to a method for detecting the weight of laundry accommodated in a washing machine.

2. Description of the Related Art

A washing machine (referred to a drum washing machine) includes a tub that contains water (washing water or rinsing water), a drum rotatably installed inside the tub to accommodate laundry, and a motor generating the driving force to rotate the drum. As the cylindrical drum rotates, the laundry accommodated in the drum ascends and descends along the inner wall of the drum, so that the laundry is washed.

Such a washing machine proceeds with washing by performing a series of operations including the washing cycle to remove dirt from the laundry by use of water (washing water, in detail) having detergent dissolved therein, a rinsing cycle to rinse lather or remaining detergent from the laundry by use of water (rinsing water, in detail) not including detergent, and a spin-dry cycle configured to spin dry the laundry at high speed. In order to proceed with washing through such a series of operations, the weight of laundry accommodated in the washing machine—in the drum, in detail—needs to be detected.

In this regard, a number of methods have been suggested to detect the weight of laundry (see, Japanese unexamined patent publication No. 2002-336593, Japanese unexamined patent publication No. 2004-267334 and Japanese unexamined patent publication No. Hei 07-90077).

The washing machine disclosed above initially detects the weight of laundry directly or indirectly by measuring the moment of inertia of the drum in a state a torque is applied to a motor for a predetermined period of time, and then also by using Newton's second law (torque=inertial acceleration), and sets the amount of water supply based on the detected weight of laundry.

However, in case of such a washing machine, imbalance may occur inside the washing machine due to the laundry unevenly distributed inside the drum. Since the circumferential position of the imbalance causes the rotation speed of the drum to be changed periodically, the degree of error in weight measurement is increased if the moment of inertia is measured for a short period of time, In this regard, the moment of inertia needs to be measured for a long period of time to prevent the imbalance from affecting the measuring of weight.

However, if the moment of inertia is measured for a long period of time by applying a torque to a motor, the rotation speed of a motor (the rotation speed of a drum) significantly changes depending on various types of external environment factors. For example, the rotation speed is influenced by physical factors, such as windage loss due to the rotation of the motor, frictional resistance of bearings, contact resistance of laundry and mechanical vibration, and electrical factors, such as detection error of rotation speed and fluctuation of power voltage, thereby causing detection error of the weight of laundry and failing to detect the precise weight of laundry.

### SUMMARY

Therefore, it is an aspect to provide a washing machine capable of calibrating an error in detecting the weight of laundry, which occurs due to external environment factors, by use of a weight detection offset data while the weight of laundry is detected using a motor, and precisely detecting the weight of laundry accommodated inside the washing machine, and a control method thereof.

Additional aspects will be set forth in part in the description which follows and, in part, will be obvious from the description, or may be learned by practice of the invention.

In accordance with one aspect, a control method of a washing machine, which is provided with a drum configured to accommodate laundry and with a motor configured to rotate the drum and detects weight of the laundry, the control method is as follows. The drum is rotated according to driving of the motor in a state that the drum does not accommodate laundry. Laundry weight is detected in the state that the drum does not accommodate laundry by use of rotation speed of the drum according to driving of the motor. A difference between the detected laundry weight in the state that the drum does not accommodate laundry and a reference value is obtained by comparing the detected laundry weight with the reference value. A calibration offset used to calibrate a weight detection error of the laundry is obtained according to the difference between the detected laundry weight in the state that the drum does not accommodate laundry and the reference value.

The detecting of the laundry weight in the state that the drum does not accommodate laundry includes performing a calibration mode of detecting laundry weight a plurality number of times in the state that the drum does not accommodate laundry, and obtaining an average of a plurality pieces of weight data that are detected through the calibration mode.

The number of times of the laundry weight detection varies with a type of the motor.

In the calibration mode, water of the washing machine is drained before the detecting of the laundry weight in the state that the drum does not accommodate laundry.

The calibration mode is performed in a door lock state that a door of the washing machine is locked.

The calibration mode is performed when the washing machine is installed.

The calibration mode is performed when a user desires to change the calibration offset.

The calibration mode is performed separately from a washing mode.

In the washing mode, laundry weight is detected by rotating the drum according to driving of the motor in a state that the drum accommodates laundry.

The control method includes calibrating the laundry weight, which is detected in the washing mode, based on the calibration offset that is obtained in the calibration mode.

In accordance with another aspect, a washing machine includes a drum, a motor, an input unit and a control unit. The drum is configured to accommodate laundry. The motor is configured to rotate the drum. The input unit is configured to select a calibration mode to perform a weight detection in a state that the drum does not accommodate laundry. The control unit is configured to obtain a weight detection value in a state that the drum does not accommodate laundry by rotating the drum according to driving of the motor if the calibration mode is selected and to obtain a calibration offset that, which is used to calibration a weight detection error of the laundry, by comparing the weight detection value in the state that the drum does not accommodate laundry with a reference value.

The control unit performs the weight detection a plurality number of times in the state that the drum does not accommodate laundry, and sets an average of a plurality pieces of weight data, which are detected through the plurality of weight detection in the state that the drum does not accommodate the laundry, as the weight detection value in a state that the drum does not accommodate laundry.

The control unit varies the number of times of the laundry weight detection with a type of the motor.

The control unit drains water of the washing machine before the detecting of the laundry weight in the state that the drum does not accommodate laundry.

The control unit performs the calibration mode in a door lock state that a door of the washing machine is locked.

The control unit performs the calibration mode when the washing machine is installed.

The control unit performs the calibration mode when a user desires to change the calibration offset.

The control unit further performs a weight detection through a washing mode in which laundry weight is detected by rotating the drum according to driving of the motor in a state that the drum accommodates laundry.

The control unit calibrates the laundry weight, which is detected in the washing mode, based on the calibration offset obtained in the calibration mode.

The control unit performs the calibration mode separately from the washing mode.

In accordance with another aspect, a control method of a washing machine, which is provided with a drum configured to accommodate laundry and a motor configured to rotate the drum and detects weight of the laundry, the control method is as follows. Laundry weight is detected in a state the drum does not accommodate laundry by rotating the drum according to driving of the motor when the washing machine is installed. A calibration offset used to calibrate a weight detection error of the laundry is obtained by comparing the laundry weight detected in the state the drum does not accommodated laundry with a reference value. Laundry weight is calculated based on the obtained calibrated offset whenever laundry weight is detected in a state that the drum accommodates laundry in a washing mode.

According to the above described washing machine and the control method thereof, a calibration mode is provided that is performed separately from a washing mode such that a detection error of the weight of laundry, which occurs due to external environment factors, is calibrated when the weight of laundry is detected using a motor. The calibration mode is provided to find the weight detection offset data of the washing machine based on external environment factors, and to store the weight detection offset data found. When the weight of laundry is detected in a next washing mode, the weight of laundry is calibrated by use of the weight detection offset data of the washing machine, so that the weight of laundry accommodated in the washing machine is precisely detected. Accordingly, the amount of water supply, the washing time, the washing operation rate, and the heater driving rate are set according to the weight of laundry, so that the energy consumption is reduced, and the efficiency of washing laundry is enhanced.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a perspective view illustrating the external appearance of an example of a washing machine.

FIG. 2 is a cross-sectional view illustrating the configuration of an example of a washing machine.

FIG. 3 is a diagram used to explain the control operation of an example of a washing machine.

FIG. 4 is a flowchart illustrating the control algorithm of a calibration mode for calibration of the weight detection error in an example of the washing machine

FIG. 5 is a flowchart illustrating the control algorithm of a washing mode for detection of laundry weight of an example of a washing machine.

FIG. 6 is a diagram illustrating detection errors at each weight level of laundry when laundry weight is detected in an example of a washing machine.

FIG. 7 is a diagram illustrating the result of calibration using weight detection offset in each weight level of laundry in an example of a washing machine.

### DETAILED DESCRIPTION

Reference will now be made in detail to the embodiments of the present invention, examples of which are illustrated in the accompanying drawings, wherein like reference numerals refer to like elements throughout.

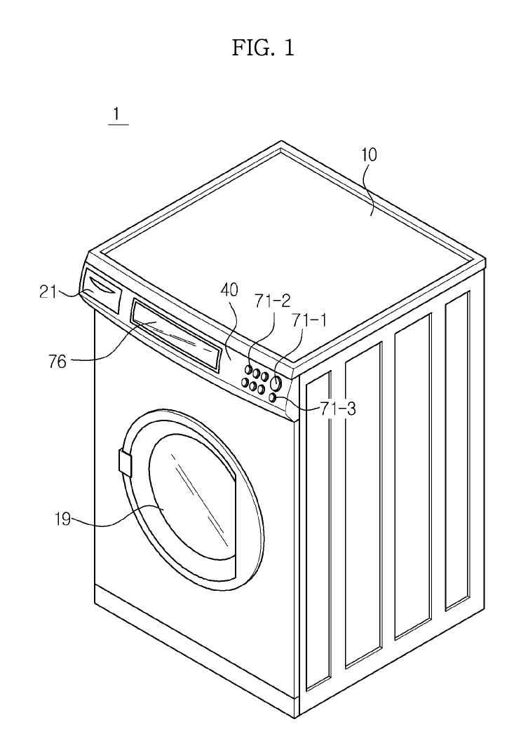

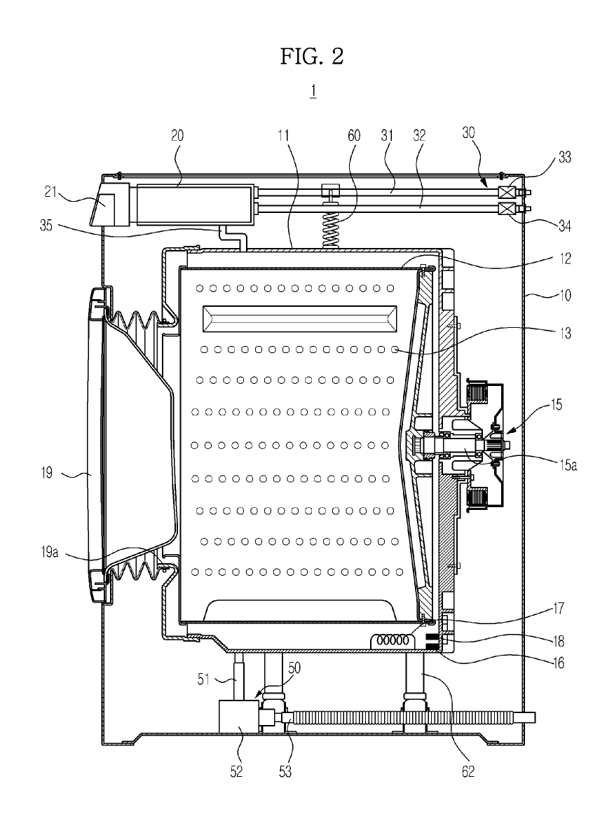

FIG. 1 is a perspective view illustrating the external appearance of an example of a washing machine. FIG. 2 is a cross-sectional view illustrating the configuration of an example of a washing machine.

Referring to FIGS. 1 and 2, a washing machine 1 includes a body forming the external appearance in a box shape, a water tub 11, which is provided in the form of a drum and installed inside the body 10 to receive water (washing and rinsing water), and a drum 12 which is provided in a cylindrical shape having a plurality of holes 13 and rotatably installed inside the water tub 11.

A motor 15 is installed at the outside of a rear side of the water tub 11 as a driving device configured to rotate a rotary shaft 15a, which is connected to the drum 12 to perform a washing cycle, a rinsing cycle, and a drying cycle.

In general, the motor 15 may be implemented using a universal motor including a field coil and an armature or a blushless direct (BLDC) motor including a permanent magnet and an electromagnet. Any motor may be used, including motor 15, as long as it is adapted to a mid-to-small size drum 12.

A water level sensor 16, a washing heater 17 and a temperature sensor 18 are installed at a lower part of the inside the tub 11. The water level sensor 16 detects the level of water contained in the water tub 11 by detecting frequency varying with the level of water. The washing heater 17 is configured to heat water contained in the water tub 11. The temperature sensor 18 is configured to detect the temperature of water (washing or rinsing water) contained in the water tub 11.

In addition, the body 10 is provided at a front side thereof with a door 19 having an opening that allows laundry to be input to or withdrawn from the inside the drum 12.

A detergent supply device 20 and a water supply device 30 are installed on the upper side of the water tub 11. The detergent supply device 20 is configured to supply detergent: for example, synthetic or natural detergent. The water supply device 30 is configured to supply water (washing water or rinsing water).

The interior of the detergent supply device 20 is divided into a plurality of spaces, and is installed on a front side of the body 10 such that a user easily adds detergent or rinsing substance into the spaces of the detergent supply device 20.

In addition, the water supply device 30 includes a cold water supply pipe 31, a hot water supply pipe 32, a cold water valve 33, a hot water valve 34, and a connection pipe 35. The cold water supply pipe 31 and the hot water supply pipe 32 connect an external water supply pipe to the detergent supply device 20. The cold water valve 33 and the hot water valve 34 are installed in the middle of the cold water supply pipe 31 and the hot water supply pipe 32, respectively, to control water supply. The connection pipe 35 is configured to connect the detergent supply device 20 to the water tub 11. Such a configuration of the connection pipe 35 allows water, which is supplied to the inside the water tub 11, to pass through the detergent supply device 20 such that both detergent and water are supplied to the water tub 11.

In addition, the body 10 is provided at a front upper side thereof with a control panel 40, on which a display unit and various buttons are disposed to control the washing machine 1. A detergent feeding part 21 is provided on one side of the control panel 40 while being connected to the detergent supply device 20 to enable detergent to be input.

Buttons from 71-1, 71-2, 71-3, and to 71n and a display unit 76 are disposed on the control panel 40. The buttons from 71-1, 71-2, 71-3, and to 71n are configured to receive an instruction from an operator of the washing machine 1. The display unit 76 is configured to display the state of operation of the washing machine 1 and the state of operation selected by a user. Buttons 71-1, 71-2, and 71-3 of the buttons labeled from 71-1, 71-2, 71-3, and to 71-n are used to select a calibration mode.

The calibration mode represents a mode of finding and saving the weight detection offset data of the washing machine 1, that is, a weight detection offset data in a state that the drum 12 does not accommodate laundry meaning that water does not exist in the water tub 11 and laundry does not exist in the drum 12. The calibration mode is performed separately from a washing mode. Since the calibration mode is a process of finding an offset data that is used to calibrate a weight detection error of laundry caused by external environment factors of the washing machine 1, the calibration mode is performed only once at the time of the installation of the washing machine 1.

In addition, a drainage device 50 is installed on the washing machine 1 to drain water contained in the water tub 11. The drainage device 50 includes a first drainage pipe 51 connected to a lower part of the water tub 11 to drain water to the outside, a drainage pump 52 installed on the first drainage pipe 51, and a second drainage pipe 53 connected to an outlet of the drainage pump 52.

In addition, the washing machine 1 is provided with a suspension spring 60, which elastically supports the water tub 11 from an upper part of the water tub 11 to prevent the vibration generated when the washing machine 1 operates, and a damper 62 reducing the vibration at a lower part of the water tub 11.

The suspension spring 60 and the damper 62 movably support the water tub 11 at the upper part and at the lower part of the water tub 11, respectively; that is, the water tub 11 is excited by an exciting force generated when the drum 112 rotates, and thus vibrated into all directions including backward/forward, left/right, and upward/downward. Such a vibration of the water tub 11 is reduced by the suspension spring 60 and the damper 62.

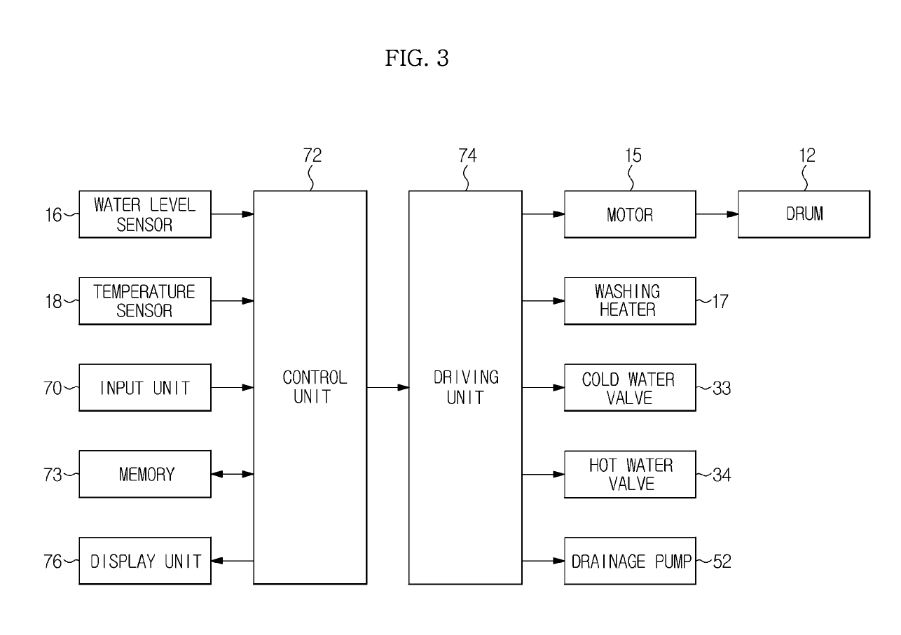

FIG. 3 is a flowchart illustrating the operation of an example of the washing machine.

Referring to FIG. 3, the washing machine 1 includes an input unit 70, a control unit 72, a memory 73, a driving unit 74, and a display unit 76.

The input unit 70 is configured to input commands to perform a washing cycle, a rinsing cycle, and a drying cycle of the washing machine 1 according to the desired operation by a user. The input unit 70 may include keys, buttons, switches, a touch pad, etc. The input unit 70 is not limited thereto, and may be implemented using various devices capable of generating a predetermined input data through operations such as pressing, touching, pushing, and rotating.

In addition, the input unit 70 is provided on the control panel 40, and includes a plurality of buttons labeled from 71-1, 71-2, 71-3, and to 71n for entering user's commands regarding various operations used to control the functions including power, delay, water temperature, soaking, washing, rinsing, dehydrating and the type of detergent. The input unit 70 includes calibration buttons labeled from 71-1, 71-2, and to 71-3 to obtain an offset data used to calibrate a weight detection error of laundry that is generated based on various external environment factors of the washing machine 1.

The control unit 72 is a micro computer configured to control the overall operation of the washing machine 1, such as washing, rinsing and dehydration, according to operation information that is input through the input unit 70. The control unit 72 sets the level of water for washing and rinsing, the target revolution per minute (RPM), the operation rate (motor on-off time), the washing time and the rinsing time.

In addition, if the calibration mode is selected, the control unit 72 finds a natural weight detection offset data corresponding to the washing machine 1 based on external environment factors of the washing machine 1, and stores the found weight detection offset data in the memory 73. The natural weight detection offset data represents a weight detection offset data obtained in a state (hereinafter, referred to an empty state) that the drum 12 does not accommodate laundry and the water tub 11 does not contain water. The natural weight detection offset data of the washing machine 1 is obtained as the average of plurality pieces of weight data that are obtained by consecutively performing weight detection two or three times in the empty state.

In addition, the control unit 72 uses the calibrating offset data to more precisely to determine the laundry weight in a next washing mode. The weight of dried laundry accommodated in the drum 12 based on the weight detection offset data in the empty state, which is obtained through the calibration mode and stored in the memory 73.

The memory 73 stores the weight detection offset data of the washing machine 1 obtained through the calibration mode; that is, the weight detection offset data in the empty state, and includes a storage medium, such as read-only memory (ROM) and electrically erasable programmable read-only memory (EEPROM).

In addition, the memory 73 may store setting information, such as a control data used to control the operation of the washing machine 1, a reference data used for operation control, an operation data generated during a process of performing a predetermined operation, and a setting data entered by the input unit 70 such that a predetermined operation is performed. Usage information, such as operation counts by which a predetermined operation is performed, and model specifications of the washing machine 1, and error information indicating the cause or the locations of an malfunction of the washing machine 1.

The driving unit 74 operates the motor 15, the washing heater 17, the cold water valve 33, the hot water valve 34 and the drainage pump 52; which are associated with the operation of the washing machine 1, according to a drive control signal of the control unit 72.

The display unit 76 is provided on the control panel 40 to display the operation state of the washing machine 1 and the operating selections made by a user according to a display control signal of the control unit 72.

In addition, the display unit 76 displays the entry or the operation state of the calibration mode through texts or images.

Hereinafter, a washing machine and a control method and operation thereof will be described.

Before detecting the weight of laundry accommodated in the drum 12 of the washing machine 1, a user or an operator selects a calibration mode to obtain an offset data, which is used to calibrate a weight detection error of laundry caused by various external environment factors of the washing machine 1 when the washing machine is first installed.

The calibration mode represents a mode of finding a natural weight detection offset data of the washing machine 1 that is, a weight detection offset data in an empty state that the drum 12 does not accommodate laundry and the water tub 11 does not accommodate water and storing the found natural weight detection offset data of the washing machine 1 to calibrate a weight detection error caused by various external environment factors of the washing machine 1. The calibration mode is performed when the washing machine 1 is first installed.

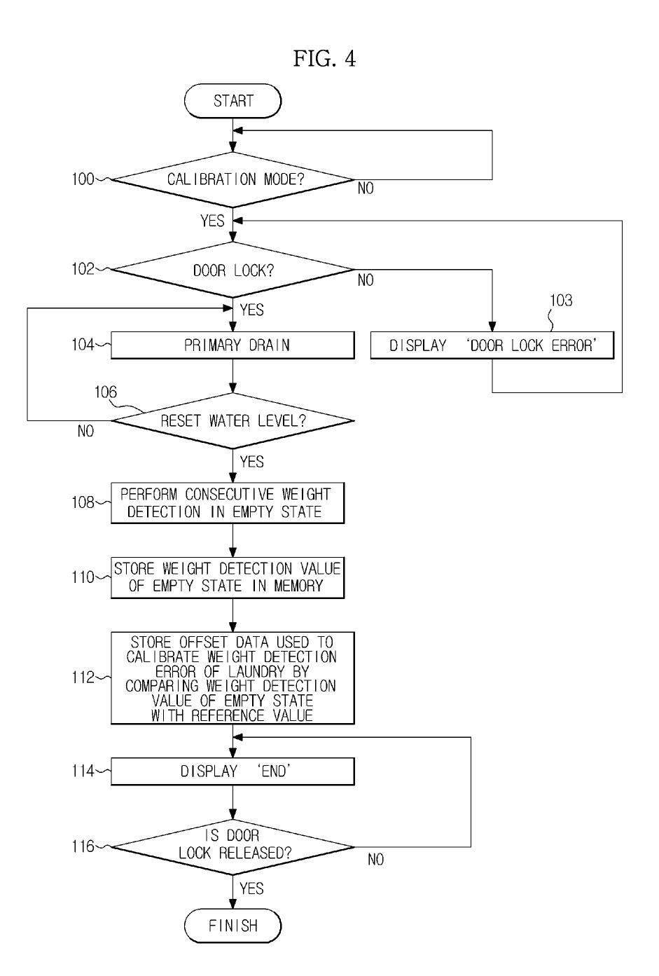

In order to select the calibration mode, an example of the calibration mode buttons 71-1, 71-2, and 71-3 are configured to serve as a power on/off button (71-1), a delay button (71-2), and a water temperature button (71-3). If the power on/off button (71-1) is pressed in a state that the delay button (71-2) and the water temperature button (71-3) are pressed at the same time, the calibration mode is selected and therefore performed. Hereinafter, the operation of the calibration mode is described with reference to FIG. 4.

FIG. 4 is a flowchart illustrating the control algorithm of a calibration mode for calibration of the weight detection error in an example of a washing machine.

Referring to FIG. 4, if a user or an operator operates the calibration mode buttons 71-1, 71-2, and 71-3 provided on the control panel 40, the operation information corresponding to the calibration mode buttons 71-1, 71-2, and 71-3 are entered to the control unit 72 through the input unit 70.

The control unit 72 determines whether the calibration mode is selected based on the operation information entered from the input unit 70 (100), and if the calibration mode is not selected, the calibration mode is on hold until it is selected.

If a result of operation 100 is that the calibration mode is selected, the control unit 72 determines whether the washing machine 1 is in a door lock state (102). If the washing machine 1 is not in a door lock state, the control unit 72 displays a ‘door lock error’ through the display unit 76 (103).

If a result of operation 102 is that the washing machine is in a door lock state, the control unit 72 allows the display unit 76 to display that the washing machine 1 enters the calibration mode and drains water before performing the calibration mode (104).

Since the calibration mode is a process of finding a natural weight detection offset data of the washing machine 1, that is, a weight detection offset data in an empty state, the control unit 72 drains water of the water tub 11 by driving the drainage pump 52 through the driving unit 74, such that water that may reside in the washing machine 1 is primarily discharged.

The control unit 72 determines whether the water tub 11 is in a predetermined reset water level at an empty level which is determined as a point of time at which water in the water tub is completely drained by allowing the water level sensor 16 to detect the level of water remaining in the water tub 11 after the draining of water (106).

If a result of operation 106 is that the level of water detected through the water level sensor 16 is not at a reset water level, the control unit 72 returns to operation 104 and continues draining water.

If a result of operation 106 is that the level of water is at a reset water level, the control unit 72 consecutively performs weight detection two or three times in a state that the washing machine 1 does not accommodate laundry; that is, in an empty state (108).

The weight detection in the empty state may be achieved by use of the time taken for a motor to reach a predetermined speed or a predetermined revolution per minute (RPM) after the motor 15 performs instantaneous acceleration. Alternatively, the weight detection in the empty state may be achieved directly or indirectly by measuring the moment of inertia of the drum in a state that a torque is applied a motor for a predetermined period of time and using Newton's second law. The method of detecting laundry weigh is not thereto, and may be implemented using various schemes as long as the weight is detected by use of the motor 15.

The weight detection based on the time taken for the motor 15 to reach a predetermined speed or a predetermined revolution per minute (RPM) by when the motor 15 performs instantaneous acceleration is as follows. Firstly, with the motor 15 accelerated to a predetermined first rotation speed, the average voltage applied to the motor 15 is detected while maintaining the constant speed at the level. Secondly, the motor 15 is then accelerated to a predetermined second rotation speed by applying the new voltage calculated in integer multiples of the average voltage detected from the previous phase. Finally, laundry weight, that is, laundry weight in an empty state is detected by use of the average voltage and the time required to accelerate the motor 15 to the second rotation speed.

Weight detection method of an empty state is performed two or three consecutive times to obtain the average weight. The average figure of weight detection data through the two or three times of weight detection serves as a weight detection value of an empty state in a state that the drum 12 does not accommodate laundry and the water tub 11 does not accommodate water.

If the number of times of the weight detection is increased, the weight detection value of an empty state is more precise. The number of times of the weight detection may vary with the type of the motor 15. In general, the weight detection is performed three times to obtain a weight detection value suitable for calibrating the weight detection error of laundry.

Thereafter, the control unit 72 stores the weight detection value of the empty state, which is obtained through performing the weight detection two or three times in the empty state, in the memory 73 (110).

The control unit 72 obtains a natural weight detection offset data of the washing machine 1, that is, an offset data, which is used to calibrate a weight detection error of laundry, by comparing the weight detection value of the empty state stored in the memory 73a with a reference value, which is preliminarily stored and represents the average weight data of a normal washing machine, and by using the difference obtained through the comparison. Then, the control unit 72 stores the obtained natural weight detection offset data in the memory 73 (112).

In addition, the control unit 72 displays such an operation state of the calibration mode through the display unit 76, thereby notifying that the calibration mode is in operation. The displaying of the operation state of the calibration mode is implemented by use of a message ‘calibration mode is in operation’ or ‘operation time of calibration mode is from two minutes to two minutes and thirty seconds’ such that a user is notified of the operation of the calibration mode.

Thereafter, the control unit 72 completes the calibration mode and at the same time displays a text ‘END’ through the display unit 76, thereby notifying a user that the calibration mode is completed (114).

When the calibration mode is completed, the control unit 72 determines whether the door lock is released (116). The control unit 72 displays a text ‘END’ through the display unit 76 until the door lock is released, and automatically ends operation after the door lock is released.

In detecting laundry weight by use the motor 15, the operation time of the calibration mode of obtaining the offset data used to calibrate the weight detection error of laundry is about two minutes or two minutes and thirty seconds. In general, the operating time of the calibration mode written on a user manual is three minutes. In addition, such a calibration mode is designed to be performed separately from the washing mode according to an instruction from a user.

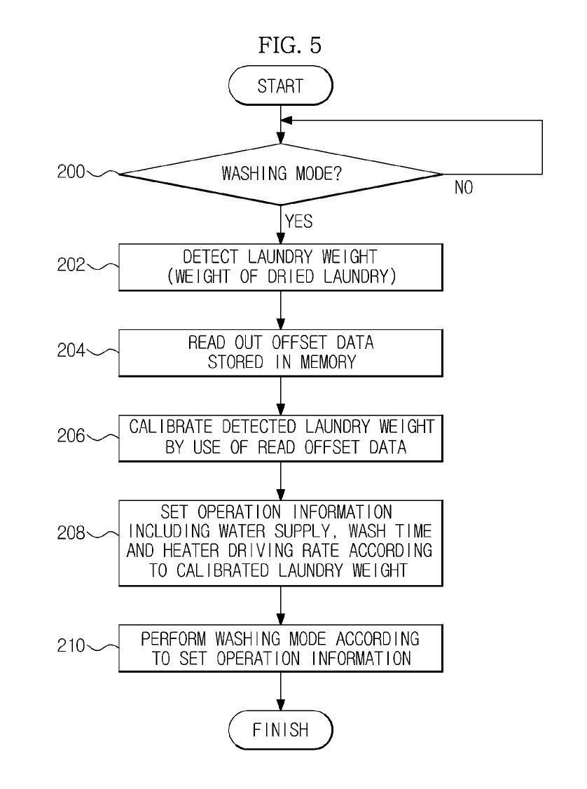

As described above, if the natural weight detection offset data of the washing machine 1, that is, the offset data used to calibrate the weight detection error of laundry, is obtained through the calibration mode, the weight of laundry in a next washing mode is calibrated based on the offset data. Hereinafter, the calibrating of the laundry weight in the next washing mode is described with reference to FIG. 5.

FIG. 5 is a flowchart illustrating the control algorithm of a washing mode for detection of laundry weight of an example of a washing machine.

Referring to FIG. 5, a user places laundry to the inside of the drum 12 and puts detergent in the detergent supply device 20. If the user enters operation information related to a washing course, for example, a standard course, and the operation of the washing machine 1 according to the type of laundry, the operation information is entered to the control unit 72 through the input unit 70.

Accordingly, the control unit 72 determines whether an operation mode is a washing mode, based on the operation information entered from the input unit 70 (200), and proceeds with the washing mode.

The control unit 72 detects the weight of laundry contained in the drum 12 to initiate the washing mode (202). Similar to the weight detection of the empty drum state in the calibration mode, the weight detection in the washing mode may be achieved by use of the time taken for a motor to reach a predetermined speed or a predetermined revolution per minute (RPM) when the motor performs instantaneous acceleration, or achieved directly or indirectly by measuring the moment of inertia of the drum in a state that a torque is applied a motor for a predetermined period of time and using Newton's second law. The method of detecting laundry weigh is not thereto, and may be implemented using various schemes as long as the weight is detected by use of the motor 15.

In this example, the detecting of laundry weight in the washing mode is achieved by performing weight detection only once, which is different from the method in measuring weight detection in the empty drum state when the calibration mode is performed two or three times. However, the weight detection in the washing mode is not limited thereto, and may be also performed a plurality number of times similar to the weight detection of the empty drum state in the calibration mode.

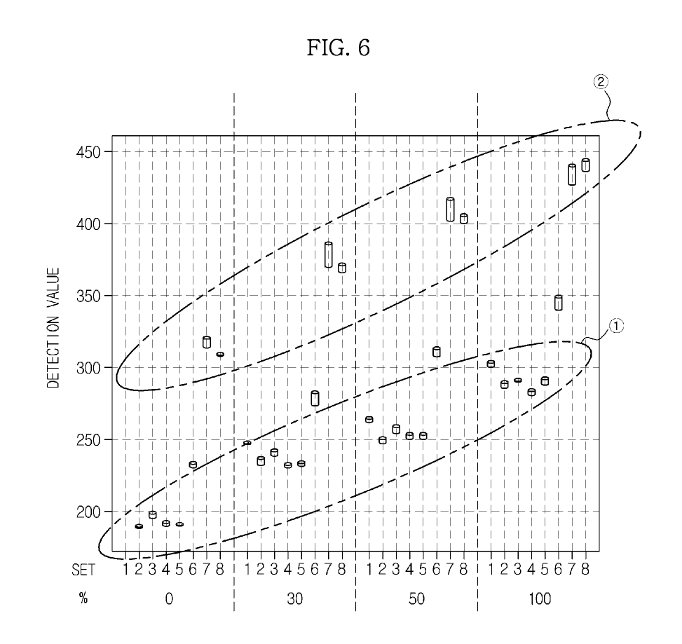

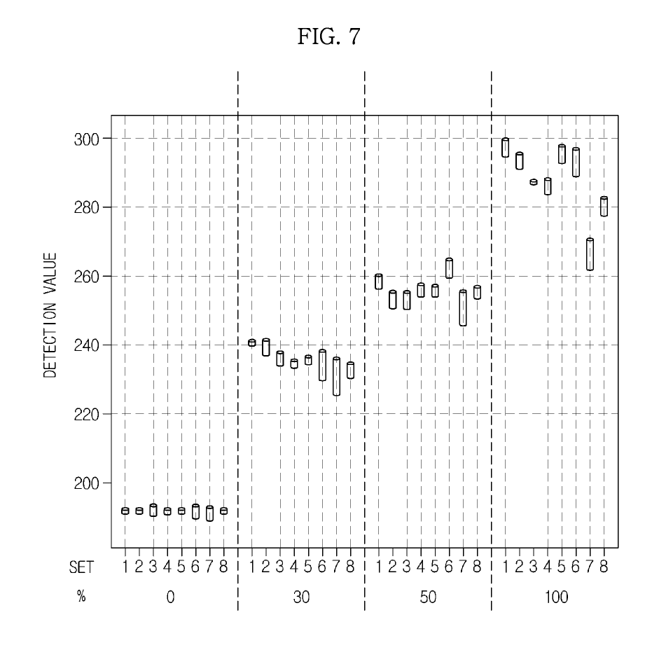

Sequentially, the control unit 72 reads a natural weight detection offset data of the washing machine 1 stored in the memory 73 through the calibration mode, that is, an offset data used to calibrate a weight detection error of laundry (204), and calibrates the weight of laundry detected in operation 202 by use of the read offset data (206). The calibration of the weight of laundry is described later with reference to FIGS. 6 and 7.

The control unit 72 precisely sets operation information, including the amount of water supply in the washing mode, the washing time in the washing mode, the washing operation rate in the washing mode, and the heater driving rate, according to the calibrated laundry weight (208), and performs the washing mode (210).

In this manner, the control unit 72 performs the washing mode based on the operation information which is precisely set according to the calibrated laundry weight, thereby reducing unnecessary energy consumption and enhancing the efficiency of washing laundry.

FIG. 6 is a diagram illustrating detection errors at each weight level of laundry when laundry weight is detected in an example of a washing machine. FIG. 6 shows weight detection values according to each weight level of 0%, 30%, 50%, and 100% of a predetermined laundry weight of 8 kg when the offset calibration mode is not performed.

In FIG. 6, a case \textcircled{1} represents values which are substantially close to the average weight detection value of a normal washing machine 1. Accordingly, the values corresponding to \textcircled{1} is stored in the memory 73 as a reference value for offset data that is used to calibrate a weight detection error of laundry.

A case \textcircled{2} represents weight detection values that are significantly deviated from the average weight detection value of the normal washing machine 1 due to various external environment factors. Referring to FIG. 6, weight detection values at a weight level of 0% in the case \textcircled{2} correspond to weight detection values at a weight level of 100% in the case \textcircled{1}.

FIG. 7 is a diagram illustrating the result of calibration at each weight level of laundry in an example of a washing machine. FIG. 7 shows weight detection values according to each weight level of 0%, 30%, 50%, and 100% of a predetermined laundry weight of 8 kg when the offset calibration mode is performed.

Weight detection values shown as the case \textcircled{2} are calibrated by use of a weight detection offset data of the washing machine 1, thereby producing a uniform calibration result at each weight level of laundry weight as shown in FIG. 7.

In this example, the calibration mode is performed once when the washing machine 1 is installed. However, the number of calibration operations is not limited thereto. If external environment factors change due to superannuation of the washing machine 1, the calibration mode is performed repeatedly to change the weight detection offset data of the washing machine 1 and to calibrate the weight detection error of laundry by use of the changed weight detection offset data.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A control method of a washing machine, which is provided with a drum configured to accommodate laundry and with a motor configured to rotate the drum and detects weight of the laundry, the control method comprising:
rotating an empty drum according to driving of the motor,
detecting laundry weight of the empty drum by use of rotation speed of the drum according to driving of the motor;
obtaining a difference between the detected laundry weight of the empty drum and a reference value; and
obtaining a calibration offset used to calibrate a weight detection error of the laundry according to the difference between the detected laundry weight of the empty drum and the reference value.

2. The control method of claim 1, wherein the detecting of the laundry weight of the empty drum comprises:
performing a calibration mode of detecting laundry weight a plurality number of times of the empty drum, and
obtaining an average of a plurality pieces of weight data that are detected through the calibration mode.

3. The control method of claim 2, wherein the number of times of the laundry weight detection varies with the type of motor.

4. The control method of claim 2, wherein in the calibration mode, water of the washing machine is drained before the detecting of the laundry weight of the empty drum.

5. The control method of claim 4, wherein the calibration mode is performed when a door of the washing machine is in a locked state.

6. The control method of claim 2, wherein the calibration mode is performed when the washing machine is installed.

7. The control method of claim 2, wherein the calibration mode is performed when a user activates the calibration mode.

8. The control method of claim 2, wherein the calibration mode is performed separately from a washing mode.

9. The control method of claim 8, wherein in the washing mode, laundry weight is detected by rotating the drum containing laundry according to driving of the motor.

10. The control method of claim 9, further comprising calibrating the laundry weight, which is detected in the washing mode, based on the calibration offset that is obtained in the calibration mode.

11. A washing machine comprising:
a drum configured to accommodate laundry;
a motor configured to rotate the drum;
an input unit configured to select a calibration mode to perform a weight detection of an empty drum; and
a control unit configured to obtain a weight detection value of the empty drum by rotating the drum according to driving of the motor if the calibration mode is selected and to obtain a calibration offset that, which is used to calibration a weight detection error of the laundry, by comparing the weight detection value in the state that the drum does not accommodate laundry with a reference value.

12. The washing machine of claim 11, wherein the control unit performs the weight detection a plurality number of times of the empty drum, and sets an average of a plurality pieces of weight data that are detected through the calibration mode.

13. The washing machine of claim 12, wherein the control unit varies the number of times of the laundry weight detection with the type of motor.

14. The washing machine of claim 12, wherein the control unit drains water of the washing machine before the detecting of the laundry weight in the state that the drum does not accommodate laundry.

15. The washing machine of claim 11, wherein the control unit performs the calibration mode when a door of the washing machine is in a locked state.

16. The washing machine of claim 11, wherein the control unit performs the calibration mode when the washing machine is installed.

17. The washing machine of claim 11, wherein the control unit performs the calibration mode when a user activates the calibration mode.

18. The washing machine of claim 11, wherein the control unit further performs a weight detection through a washing mode in which laundry weight is detected by rotating the drum containing laundry according to driving of the motor.

19. The washing machine of claim 18, wherein the control unit calibrates the laundry weight, which is detected in the washing mode, based on the calibration offset obtained in the calibration mode.

20. The washing machine of claim 18, wherein the control unit performs the calibration mode separately from the washing mode.

21. A control method of a washing machine, which is provided with a drum configured to accommodate laundry and a motor configured to rotate the drum and detects weight of the laundry, the control method:
detecting laundry weight in a state the of an empty drum according to driving of the motor when the washing machine is installed;
obtaining a calibration offset used to calibrate a weight detection error of the laundry by comparing the laundry weight detected in the state of an empty drum with a reference value; and
calibrating laundry weight based on the obtained calibrated offset whenever laundry weight is detected in a state that the drum accommodates laundry in a washing mode.
